(19) United States
(12) Patent Application Publication
(10) Pub. No.: US 2025/0131518 A1
(43) Pub. Date: Apr. 24, 2025

(54) SYSTEM FOR DETERMINING PRODUCT STRATEGIES BASED ON PRODUCT AND IP ASSET DATA AND META DATA

(71) Applicant: ANAQUA INC, BOSTON, MA (US)

(72) Inventor: PATRICK TERRY, BOSTON, MA (US)

(21) Appl. No.: 18/383,214

(22) Filed: Oct. 24, 2023

(51) Int. Cl. G06Q 50/18; G06Q 30/0202

(52) U.S. Cl. CPC G06Q 50/184; G06Q 30/0202

(57) ABSTRACT

A method and system for determining strategies with regards to product protection and market exclusivity. The method and system including various processes to determine product protection and market exclusivity based on various information from both the product side, such as clinical trial dates, revenue, naming conventions, time to market, and/or other regulatory and product strategy aspects, and from the intellectual property side, such as patent file dates, patent term extensions, trademarks, or other intellectual property strategies and requirements.

### BACKGROUND

When planning a patent strategy, for filings, payments, or any other strategies, companies are looking for the most cost-effective strategy that they can determine. Not only from a cost savings perspective, but from a revenue creation perspective. Especially from a revenue creation perspective, patent protection coverage or other coverage based on patent, trademarks, or other intellectual property assets (hereinafter “IP” or “IP assets”) or data or metadata from IP assets can play a huge part in this.

Often people simply use their intuition to make best guesses for what will allow them the most coverage, protection, market exclusivity, etc. The more experienced a person is, of course, the more likely they are close to what will work. But even the best and most experienced people may create a strategy that misses the mark by a few months to a few years. Even a few months can mean a tremendous amount of lost revenue for the business. Depending on the product, this can literally mean millions or more.

Most of the time, all of this data is stored inside of their various Intellectual Property Management Systems (hereinafter “IPMS”), or some set of software that the companies use to store various IP assets or data associated with those IP assets. This can be dates, costs, revenue forecasts for those assets, and a tremendous amount of other data that is directly or peripherally associated with those IP assets. However, there is little to no way for an individual to simply look at all of that and figure out, in their head, what the actual strategy should be and how best to use all of that data. And to date, existing systems cannot do these types of calculations and work out best practices for the company's strategy either. The IPMS simply presents the data and allows the person or company to come up with their own strategy.

For example, an IPMS may know when a particular expiration date is, or when an annuity is due, or even how long a company has before the deadline is when they're able to file in another country or a continuation or whatever other filing dates exist. These dates are generally static and calculated based on the laws of the particular authority. For example, the system may know what the filing deadline is for a non-provisional in the USPTO after a user inputs the filing date of a provisional patent. And can then update the field that tells the user when the last day to file said non-provisional is.

The system of the present invention introduces a new concept in the asset management system. Rather than simple date calculations to inform the user there is a deadline coming up, the system provides best practice solutions to a user or a company around a more complete strategy, rather than a simple “this is the deadline date” approach.

In other words, there is more to planning a complete strategy than just knowing the final date to file. There are other aspects of filing that can change the actual length of protection for a given, say, product. Being able to understand more of the entire strategy and more of the aspects that go into protections can allow a user to gain an extra few months of protection (or even make sure they are getting 100% of the allowed protection). Although in some cases, a few months may mean very little from a revenue standpoint, in some cases, this may mean literally millions of dollars in revenue that can be lost by not understanding how to best plan your IP strategy.

With assistance from the system in the present invention, a user can then understand what is best for their strategy to help maximize their assets and help understand best practices so as not to lose precious coverage.

These and other aspects, objects, and features of the present invention will be understood and appreciated by those skilled in the art upon studying the following specification, claims, and appended drawings.

### BRIEF DESCRIPTION OF THE DRAWINGS

FIG. 1 depicts a block diagram of a network of data processing systems in which illustrative embodiments may be implemented;

FIG. 2 depicts a flowchart of an example process for the present invention to determine the requested strategy.

### DETAILED DESCRIPTION OF THE INVENTION

Various aspects of the system and method of the present invention disclosed herein, along with the accompanying drawings referenced herein, are intended to be exemplary and not limiting. It is understood that other embodiments may be utilized and fall within the scope of the appended claims without departing from the spirit of the invention.

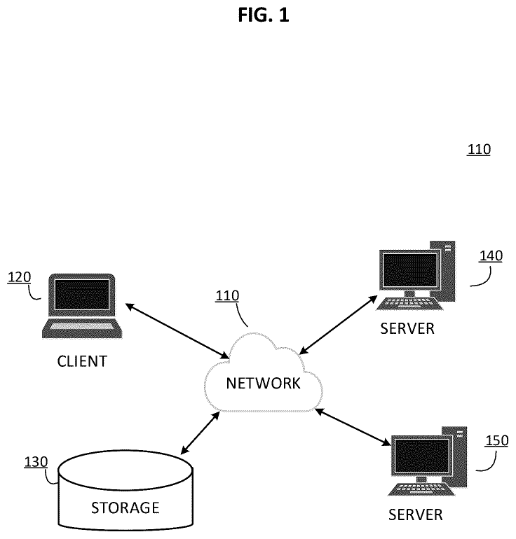

FIG. 1 depicts a block diagram of a network of data processing systems in which illustrative embodiments may be implemented. Data processing environment 100 is a network of computers in which the illustrative embodiments may be implemented. Data processing environment 100 includes network 110. Network 110 is the medium used to provide communications links between various devices, computers, etc. connected together within data processing environment 100. Network 110 may include, but are not limited to, connections, such as wired, wireless communication links, or fiber optic cables.

Clients or servers are only example roles of certain data processing systems connected to network 110, and are not intended to exclude other configurations or roles for these data processing systems. Server 140 and server 150, in this example, couple to network 110 along with storage unit 130. Software applications may execute on any computer in data processing environment 100. Client 120 is also coupled to network 110. A data processing system or a data storage system, such as server 140 or 150, client 120, or storage 130 may contain data and may have software applications or software tools executing thereon, including, but not limited to, software and data relevant to the current invention. Said data may include public or private data or both, depending on the implementation or embodiment.

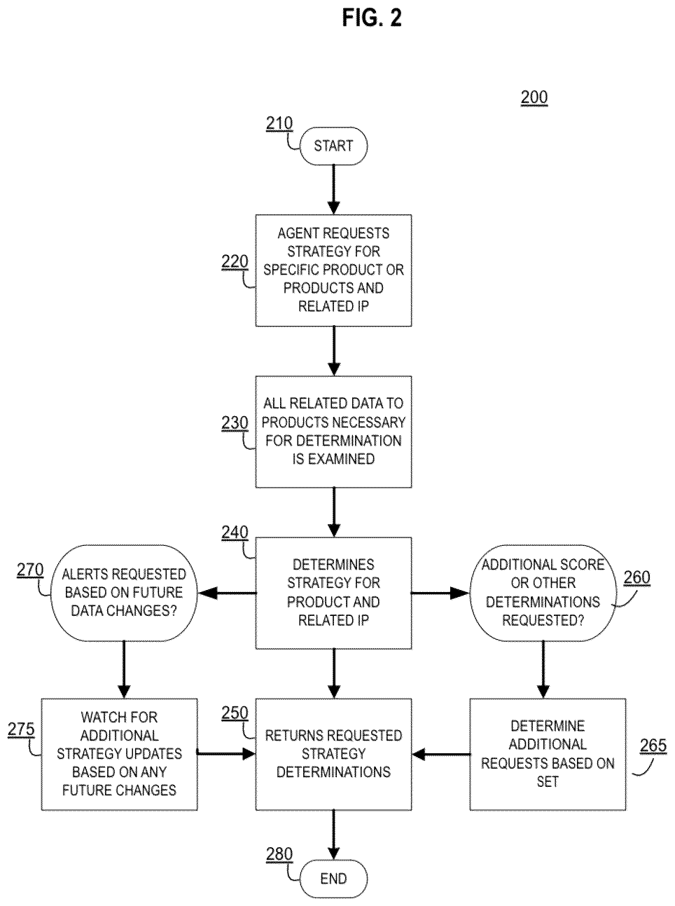

FIG. 2 depicts a flowchart of an example process for the present invention to determine the requested strategy. In some embodiments of the present invention, an attorney, patent agent, product manager, or other person or persons associated with the company that helps set strategy or works with the company's IP assets (hereinafter “agent”) requests a particular strategy for a product or products and any related IP Assets 220. The present invention will find any data related to these products and related IP Assets that is determined by the present invention, by the agent, or both that is relevant and necessary to make the requested determinations for the strategy 230. Once the data is retrieved, the present invention uses said data to make determinations of strategy 240, any other additional determinations or requests 260, 265, 270, and/or 275, and then returns the requested strategy 250, based on one or more embodiments below, or one or more embodiments that can be determined or inferred by one having ordinary skill in the art from the information contained in the present application.

In its simplest exemplary embodiment, the present invention is a method for understanding how to maximize coverage and protection of a user's assets, through internal and/or external data. In some embodiments, assets may be, but are not limited to, IP assets, products (for example, pharmaceutical products, manufactured goods, or other products that may be directly or indirectly protected by one or more IP assets), or other items considered related to the goods, services, or other assets.

In one exemplary embodiment, a pharmaceutical company is trying to determine the maximum protection as provided by the USPTO and the USFDA (the US Food and Drug Administration). In this example, there are specific time limits for filing various pieces of the process for the pharmaceutical process. For example, there may be filing for patents, filing for clinical trials, filing for patent term extensions (hereinafter “PTE”), or other filings and pieces of the pharmaceutical and IP process. Filing at different times during this time limit creates a different expiration. However, in some instances, there are other factors besides a simple time limit that sets the expiration. In some instances, simply filing at the end of the time will not create the longest market exclusivity, allow the company to use up the maximum amount of PTE, or other choices or data to maximize the company's strategies. In some embodiments, agent uses the present invention to help maximize the strategy. In some embodiments, the agent uses the present invention with the company's IPMS or other systems that include data relevant to the strategy calculation. The present invention uses multiple pieces of information including, but not limited to, file and grant dates of IP assets related to the product or products for the company strategy, PTE, data from various regulatory agencies such as file dates with the FDA or clinical study dates with said regulatory agencies, or lifespans on both the pharma regulatory side and the IP side. The present invention uses all of this data to calculate the best filing times to maximize the company strategy with regard to market exclusivity.

In some exemplary embodiments, the present invention may take data from the company's IPMS or other systems that include data relevant to the strategy calculation, and may allow the agent to tweak certain aspects of the calculation to define the best strategy for the company. For example, the present invention may determine that the way to use up 98% of the available exclusivity is to file particular patents or requests for PTE or other aspects of the process in 5 years. However, the strategy in this example may be that the company would like to make it to market in 2 years. The agent inputs this change into the present invention and the calculations return that by following this strategy, 96% of the available exclusivity will be able to be used. In some embodiments, the agent determines that this is preferable. In an exemplary embodiment, the agent tells the present invention to continue with a particular strategy and the present invention passes the information and/or makes the necessary changes in the IPMS or other systems to allow the agent's requested strategy to occur.

In an embodiment, the present invention makes decisions based on IP assets from a single country. In another exemplary embodiment, the present invention makes decisions based on the IP assets from multiple countries. For example, the filing strategy in one country, such as a Japanese strategy and the IP assets in Japan, may inform the available exclusivity in the United States. In this example, it may be determined that certain filings in Japan 6 months later than expected increases the market exclusivity in the United States by a significant amount. In some embodiments, the present invention can make determinations based on multiple different assets from multiple different countries to determine the strategy the agent and company should pursue in one or multiple countries for one or multiple products. These determinations may include determinations about the same country that an agent is looking at (for example, looking at Japanese filings may affect the Japanese strategy), or other countries that the agent is looking for strategy decisions about (for example, looking at Japanese filings may affect the strategy in multiple other countries), or both.

In some embodiments, the present invention may determine and present or more different strategies to the agent. In some embodiments these strategies are presented as raw data, such as, but not limited to, the dates to file, the percent of PTE used, and the length of market exclusivity. In other embodiments, the present invention may determine and present one or more strategies to the agent that includes some sort of score indication based on various factors, such as, but not limited to, market exclusivity length and revenue associated with filing times. These score indications may include a ranking, color coding, or other indications of recommendations. In some embodiments, these score indications may be set by the agent, preset by others, or a combination of both.

In yet other embodiments, the present invention may take information such as expected dates, PTE, or other relevant data from the IPMS, the agent, or both. In some embodiments, the present invention adapts to changing data to determine if the strategy should be changed. For example, the IPMS, other systems, or both may be updated with some date change, such as the estimated date for the grant of the patent or the actual submission date. Based on changes such as these, the present invention may determine that Strategy 1 that was the best is now not as good as Strategy 2 based on factors important to the company. In some embodiments, the present invention may alert the agent to said change to see if the agent wants to change the strategy. In one embodiment, the agent may simply accept the new strategy and the present invention updates the necessary people and data to reflect this change. In other exemplary embodiments, the present invention may automatically update the strategy in the system based on parameters such as the agent telling the present invention that if the new data adds more than a certain percentage of revenue, market exclusivity, or other changes, that the systems, relevant data, people, or other pieces of the process (or multiple of these) is to be updated automatically. This may or may not include updating the agent to the changes and the new strategy.

In some exemplary embodiments, the product side may be the driving factor for the strategy decisions. For example, in filing pharmaceuticals, the product must go through multiple clinical trials, may have various revenue forecasts that may change from country to country, may have one or more go-no go decisions, or have other factors that are found to be the most important factors for driving the strategy decisions. In other exemplary embodiments, the IP side may be the driving factor for the strategy decisions. For example, there may be multiple types of patents that have very strict timelines to file, or there may be multiple different sets of patent exclusivity and/or PTE from various countries, or other aspects of the IP process that are determined to be the most important factors for driving the strategy decisions. In yet other embodiments, a combination of one or more factors from both the product side and the IP side may be determined to be the most important factors for driving the strategy decisions.

In some embodiments, the purpose of the present invention is to create a strategy to maximize revenue from a particular product. In other embodiments, the purpose of the present invention is to create a strategy a strategy to maximize market exclusivity of a particular product, such as a pharmaceutical product. In yet other embodiments, the purpose of the present invention is to create a strategy to block a competitor's access to the market. In still other embodiments, the purpose of the present invention is to create a strategy that allows for the most cost-efficient strategy for the company. In yet other embodiments, the purpose of the present invention is to create a strategy built around some or all of these various embodiments, depending on preset determined factors from the company, inputs from the agent, or both.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature. Additionally, any countries, jurisdictions, or specific nouns, such as the names of certain government agencies, mentioned in any embodiment in this specification is only for illustrative purposes and is not to be considered as limiting in any fashion.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for determining an intellectual property strategy, the method comprising:
receiving a request for one or more strategy decisions for one or more products and one or more intellectual property assets related to said one or more products;
retrieving data related to the one or more products, the related one or more intellectual property assets, or any combination, that is relevant to determining the requested one or more strategy decisions;
using the retrieved data to make determinations of the one or more strategy decisions; and
presenting the requested one or more strategy decisions to one or more users.

2. The method of claim 1:
wherein the retrieved data includes data from one or more regulatory or government agencies, and said retrieved data can include data from or related to one or more countries.

3. The method of claim 1:
wherein the retrieved data includes lifespans, file dates, grant dates, regulatory dates, patent term extension (PTE), percent of PTE used, length of market exclusivity, or any combination thereof, and said retrieved data can include data from or related to one or more countries.

4. The method of claim 1:
wherein the purpose of the strategy is to maximize revenue from the one or more products, to maximize market exclusivity of the one or more products, to block a competitor's access to the market, to create a cost-efficient strategy for the company, or any combination thereof, and the determinations of the one or more strategy decisions reflects this.

5. The method of claim 1:
wherein the retrieved data includes data from one or more Intellectual Property Management Systems (IPMS).

6. The method of claim 1:
wherein the retrieved data, systems, or both are updated based on selections presented to the user, other data retrieved by the user, or any combination thereof.

7. The method of claim 1:
wherein the presented strategy includes a score indication based on factors such as, but not limited to, market exclusivity length, revenue associated with filing times, internal rankings, external rankings, market forces, or any combination thereof.

8. A computer processing system for determining an intellectual property strategy, the system comprising:
a memory; and
a processor communicatively coupled to the memory, wherein the system performs a method comprising:
receiving a request for one or more strategy decisions for one or more products and one or more intellectual property assets related to said one or more products;
retrieving data related to the one or more products, the related one or more intellectual property assets, or any combination, that is relevant to determining the requested one or more strategy decisions;
using the retrieved data to make determinations of the one or more strategy decisions; and
presenting the requested one or more strategy decisions to one or more users.

9. The method of claim 8:
wherein the retrieved data includes data from one or more regulatory or government agencies, and said retrieved data can include data from or related to one or more countries.

10. The method of claim 8:
wherein the retrieved data includes lifespans, file dates, grant dates, regulatory dates, patent term extension (PTE), percent of PTE used, length of market exclusivity, or any combination thereof, and said retrieved data can include data from or related to one or more countries.

11. The method of claim 8:
wherein the purpose of the strategy is to maximize revenue from the one or more products, to maximize market exclusivity of the one or more products, to block a competitor's access to the market, to create a cost-efficient strategy for the company, or any combination thereof, and the determinations of the one or more strategy decisions reflects this.

12. The method of claim 8:
wherein the retrieved data includes data from one or more Intellectual Property Management Systems (IPMS).

13. The method of claim 8:
wherein the retrieved data, systems, or both are updated based on selections presented to the user, other data retrieved by the user, or any combination thereof.

14. The method of claim 8:
wherein the presented strategy includes a score indication based on factors such as, but not limited to, market exclusivity length, revenue associated with filing times, internal rankings, external rankings, market forces, or any combination thereof.

15. A computer program product for determining an intellectual property strategy, the program instructions executable by a processor to cause the processor to perform a method comprising:
receiving a request for one or more strategy decisions for one or more products and one or more intellectual property assets related to said one or more products;
retrieving data related to the one or more products, the related one or more intellectual property assets, or any combination, that is relevant to determining the requested one or more strategy decisions;
using the retrieved data to make determinations of the one or more strategy decisions; and
presenting the requested one or more strategy decisions to one or more users.

16. The computer program product of claim 15:
wherein the retrieved data includes data from one or more regulatory or government agencies, and said retrieved data can include data from or related to one or more countries.

17. The computer program product of claim 15:
wherein the retrieved data includes lifespans, file dates, grant dates, regulatory dates, patent term extension (PTE), percent of PTE used, length of market exclusivity, or any combination thereof, and said retrieved data can include data from or related to one or more countries.

18. The computer program product of claim 15:
wherein the purpose of the strategy is to maximize revenue from the one or more products, to maximize market exclusivity of the one or more products, to block a competitor's access to the market, to create a cost-efficient strategy for the company, or any combination thereof, and the determinations of the one or more strategy decisions reflects this.

19. The computer program product of claim 15:
wherein the retrieved data includes data from one or more Intellectual Property Management Systems (IPMS).

20. The computer program product of claim 15:
wherein the retrieved data, systems, or both are updated based on selections presented to the user, other data retrieved by the user, or any combination thereof.
